(19) United States
(12) Patent Application Publication
(10) Pub. No.: US 2004/0114755 A1
(43) Pub. Date: Jun. 17, 2004

(54) Telephone cord having a digital transmission

(76) Inventor: Jonathan Li, Tainan (TW)

Correspondence Address: Alan D. Kamrath, Rider, Bennett, Egan & Arundel, LLP, Suite 2000, 333 South Seventh Street, Minneapolis, MN, 55402, US

(21) Appl. No.: 10/317,473

(22) Filed: Dec. 12, 2002

(51) Int. Cl. H04M 1/00; H04M 9/00

(52) U.S. Cl. 379/438

(57) ABSTRACT

A telephone cord having a digital transmission includes six lines and has two ends each provided with a connecting terminal which is formed with six insertion slots each mating with and connected to a corresponding one of the six lines for insertion of one of six metallic guide plates. When either one of the metallic guide plates is inserted into the respective insertion slot, the metallic guide plate is electrically connected to the respective line of the telephone cord. Thus, the telephone cord has double functions of telephone communication and digital network communication, so that the telephone cord combines the functions of the ordinary telephone cord and the ordinary network cord, thereby greatly enhancing the versatility of the telephone cord.

### BACKGROUND OF THE INVENTION

1. Field of the Invention

The present invention relates to a telephone cord having a digital transmission, and more particularly to a telephone cord having a digital transmission, wherein the telephone cord has the double functions of telephone communication and digital network communication, so that the telephone cord combines the functions of the ordinary telephone cord and the ordinary network cord, thereby greatly enhancing the versatility of the telephone cord.

2. Description of the Related Art

A conventional telephone cord in accordance with the prior art comprises six lines including a first line, a second line, a third line, a fourth line, a fifth line and a sixth line. The six lines of the telephone cord construct three transmission line sets, including a first set consisting of the first line and the sixth line, a second set consisting of the second line and the fifth line and a third set consisting of the third line and the fourth line. On the other hand, the digital network system is connected by the network cord. However, the telephone transmission only uses the third set consisting of the third line and the fourth line without using the first set and the second set, thereby decreasing the versatility of the conventional telephone cord. In addition, the telephone cord and the network cord are separated from each other and cannot be combined together, so that the telephone cord and the network cord are easily tangled with each other, thereby causing inconvenience to the user, and thereby affecting use of the space.

### SUMMARY OF THE INVENTION

The present invention has arisen to mitigate and/or obviate the disadvantage of the conventional telephone cord.

The primary objective of the present invention is to provide a telephone cord having a digital transmission, wherein the telephone cord has the double functions of telephone communication and digital network communication, so that the telephone cord combines the functions of the ordinary telephone cord and the ordinary network cord, thereby greatly enhancing the versatility of the telephone cord.

Another objective of the present invention is to provide a telephone cord having a digital transmission, wherein the telephone cord uses two transmission line sets including the first and sixth lines of the telephone cord and the second and fifth lines of the telephone cord to perform the signal transmission in an electric power carrier manner, thereby forming the digital network communication.

A further objective of the present invention is to provide a telephone cord having a digital transmission, wherein when two metallic guide plates are each inserted into the respective insertion slot corresponding to the third line and the fourth line of the telephone cord respectively, the telephone cord has the telephone communication function.

A further objective of the present invention is to provide a telephone cord having a digital transmission, wherein when the metallic guide plates are each inserted into the respective insertion slot corresponding to the first and sixth lines of the telephone cord or the second and fifth lines of the telephone cord respectively, the telephone cord has the digital network communication function.

A further objective of the present invention is to provide a telephone cord having a digital transmission, wherein when all of the six metallic guide plates are each inserted into the respective insertion slot corresponding to the first line, the second line, the third line, the fourth line, the fifth line and the sixth line of the telephone cord respectively, the telephone cord has the telephone communication function and the digital network communication function.

In accordance with the present invention, there is provided a telephone cord having a digital transmission, comprising six lines including a first line, a second line, a third line, a fourth line, a fifth line and a sixth line and having two ends each provided with a connecting terminal, the connecting terminal being formed with six insertion slots each mating with and connected to a corresponding one of the six lines for insertion of one of six metallic guide plates, so that when either one of the metallic guide plates is inserted into the respective insertion slot of the connecting terminal, the metallic guide plate is electrically connected to the respective line of the telephone cord, wherein:

at least two of the metallic guide plates are selectively inserted into the two respective insertion slots of the connecting terminal to correspond to the two respective lines of the telephone cord.

Preferably, two of the six metallic guide plates metallic guide plates are each inserted into the respective insertion slot corresponding to the third line and the fourth line of the telephone cord respectively, so that the telephone cord has a telephone communication function.

Alternatively, two of the six metallic guide plates metallic guide plates are each inserted into the respective insertion slot corresponding to the first line and the sixth line of the telephone cord respectively, so that the telephone cord has a digital network communication function.

Alternatively, two of the six metallic guide plates metallic guide plates are each inserted into the respective insertion slot corresponding to the second line and the fifth line of the telephone cord respectively, so that the telephone cord has a digital network communication function.

Alternatively, all of the six metallic guide plates metallic guide plates are each inserted into the respective insertion slot corresponding to the six lines of the telephone cord respectively, so that the telephone cord has a telephone communication function and a digital network communication function.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a telephone cord having a digital transmission in accordance with a preferred embodiment of the present invention;

FIG. 2 is a perspective view of the telephone cord having a digital transmission in accordance with the preferred embodiment of the present invention;

FIG. 3 is a perspective view of the telephone cord having a digital transmission in accordance with the preferred embodiment of the present invention;

FIG. 4 is an exploded perspective assembly view of an inverter device and the telephone cord having a digital transmission in accordance with the present invention;

FIG. 4A is a partially enlarged view of the inverter device as shown in FIG. 4; and

FIG. 5 is a flow chart of the inverter device and the telephone cord having a digital transmission in accordance with the present invention.

### DETAILED DESCRIPTION OF THE INVENTION

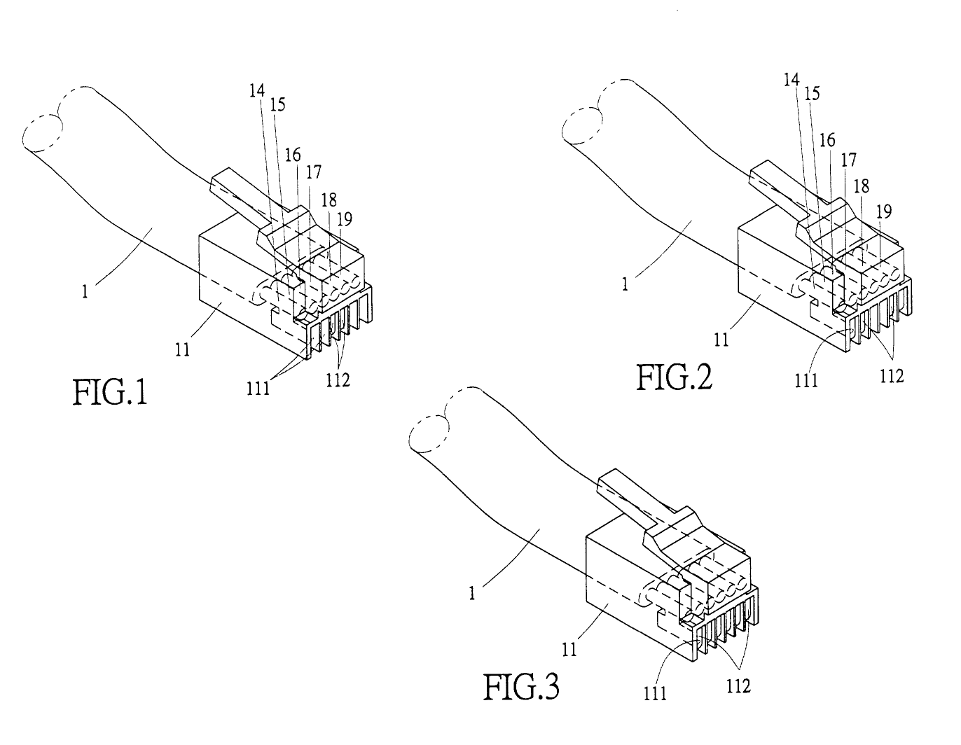

Referring to the drawings and initially to FIGS. 1-3, a telephone cord 1 having a digital transmission in accordance with a preferred embodiment of the present invention comprises six lines including a first line 14, a second line 15, a third line 16, a fourth line 17, a fifth line 18 and a sixth line 19. The six lines of the telephone cord 1 construct three transmission line sets, including a first set consisting of the first line 14 and the sixth line 19, a second set consisting of the second line 15 and the fifth line 18 and a third set consisting of the third line 16 and the fourth line 17.

The telephone cord 1 has two ends each provided with a connecting terminal 11. The connecting terminal 11 is formed with six insertion slots 111 each mating with and connected to a corresponding one of the six lines 14 to 19 for insertion of one of six metallic guide plates 112. When the metallic guide plate 112 is inserted into the insertion slot 111 of the connecting terminal 11, the metallic guide plate 112 is electrically connected to the respective line of the telephone cord 1.

As shown in FIG. 1, two metallic guide plates 112 are each inserted into the respective insertion slot 111 corresponding to the third line 16 and the fourth line 17 of the telephone cord 1 respectively. Thus, the telephone cord 1 functions as a connecting cord connected to the telephone network for use of the telephone communication.

As shown in FIG. 2, four metallic guide plates 112 are each inserted into the respective insertion slot 111 corresponding to the first line 14, the second line 15, the fifth line 18 and the sixth line 19 of the telephone cord 1 respectively. Thus, the telephone cord 1 functions as a connecting cord connected to the electric power carrier digital network for use of the carrier digital transmission. It is appreciated that, when the first line 14 and the sixth line 19 of the telephone cord 1 or the second line 15 and the fifth line 18 of the telephone cord 1 are connected by the metallic guide plates 112, the telephone cord 1 can function as a connecting cord connected to the electric power carrier digital network for use of the carrier digital transmission.

As shown in FIG. 3, six metallic guide plates 112 are each inserted into the respective insertion slot 111 corresponding to the first line 14, the second line 15, the third line 16, the fourth line 17, the fifth line 18 and the sixth line 19 of the telephone cord 1 respectively. Thus, the telephone cord 1 functions as a connecting cord connected to the telephone network for use of the telephone communication, and also functions as a connecting cord connected to the electric power carrier digital network for use of the carrier digital transmission.

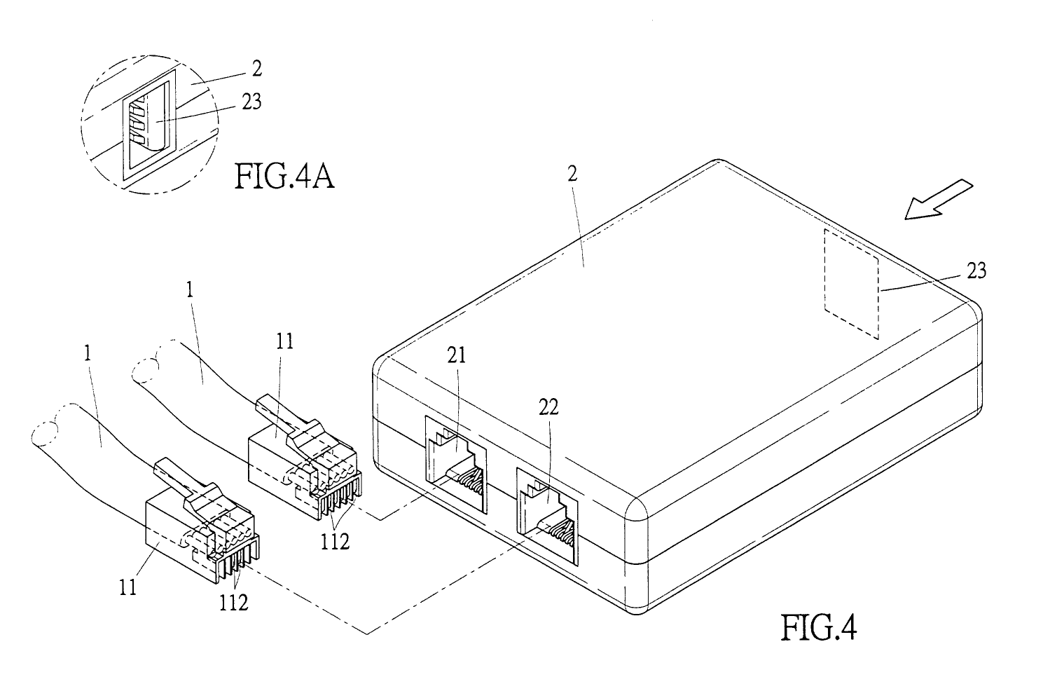

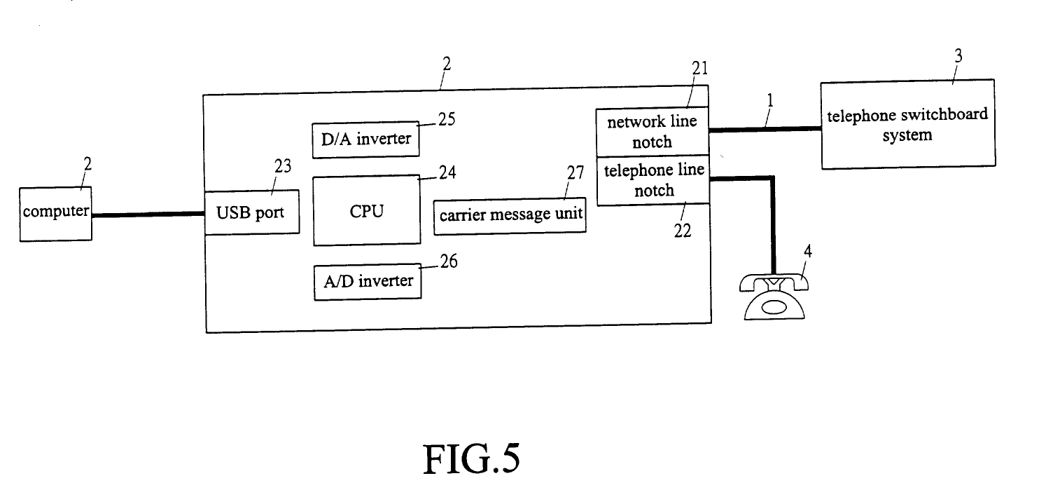

Referring to FIGS. 4, 4A and 5, the telephone cord 1 of the electric power carrier digital network is connected between an inverter device 2 and a telephone switchboard system 3. The inverter device 2 has a wall formed with a network line notch 21, a telephone line notch 22, and a USB (universal serial bus) port 23.

The network line notch 21 of the inverter device 2 is used for insertion of the connecting terminal 11 of the telephone cord 1 having the double functions of the telephone communication and the carrier digital transmission. The other end of the telephone cord 1 is connected to the telephone switchboard system 3.

The telephone line notch 22 of the inverter device 2 is used for insertion of the connecting terminal 11 of the telephone cord 1 only having the function of the telephone communication. The other end of the telephone cord 1 is connected to the telephone 4.

The USB port 23 of the inverter device 2 is used for connection between the inverter device 2 and the computer 5.

The inverter device 2 has an inside provided with a CPU (central processing unit) 24, a D/A (digital/analogue) inverter 25, an A/D (analogue/digital) inverter 26, and a carrier message unit 27.

Accordingly, the telephone cord 1 having a digital transmission in accordance with the present invention has the following advantages.

1. The telephone cord 1 uses two transmission line sets including the first and sixth lines 14 and 19 of the telephone cord 1 and the second and fifth lines 15 and 18 of the telephone cord 1 to perform the signal transmission in an electric power carrier manner, thereby forming the digital network communication.

2. When two metallic guide plates 112 are each inserted into the respective insertion slot 111 corresponding to the third line 16 and the fourth line 17 of the telephone cord 1 respectively, the telephone cord 1 has the telephone communication function.

3. When the metallic guide plates 112 are each inserted into the respective insertion slot 111 corresponding to the first and sixth lines 14 and 19 of the telephone cord 1 or the second and fifth lines 15 and 18 of the telephone cord 1 respectively, the telephone cord 1 has the digital network communication function.

4. When all of the six metallic guide plates 112 are each inserted into the respective insertion slot 111 corresponding to the first line 14, the second line 15, the third line 16, the fourth line 17, the fifth line 18 and the sixth line 19 of the telephone cord 1 respectively, the telephone cord 1 has the telephone communication function and the digital network communication function.

5. The telephone cord 1 has the double functions of telephone communication and digital network communication, so that the telephone cord 1 combines the functions of the ordinary telephone cord and the ordinary network cord, thereby greatly enhancing the versatility of the telephone cord 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A telephone cord having a digital transmission, comprising six lines including a first line, a second line, a third line, a fourth line, a fifth line and a sixth line and having two ends each provided with a connecting terminal, the connecting terminal being formed with six insertion slots each mating with and connected to a corresponding one of the six lines for insertion of one of six metallic guide plates, so that when either one of the metallic guide plates is inserted into the respective insertion slot of the connecting terminal, the metallic guide plate is electrically connected to the respective line of the telephone cord, wherein:
at least two of the metallic guide plates are selectively inserted into the two respective insertion slots of the connecting terminal to correspond to the two respective lines of the telephone cord.

2. The telephone cord having a digital transmission in accordance with claim 1, wherein two of the six metallic guide plates metallic guide plates are each inserted into the respective insertion slot corresponding to the third line and the fourth line of the telephone cord respectively, so that the telephone cord has a telephone communication function.

3. The telephone cord having a digital transmission in accordance with claim 1, wherein two of the six metallic guide plates metallic guide plates are each inserted into the respective insertion slot corresponding to the first line and the sixth line of the telephone cord respectively, so that the telephone cord has a digital network communication function.

4. The telephone cord having a digital transmission in accordance with claim 1, wherein two of the six metallic guide plates metallic guide plates are each inserted into the respective insertion slot corresponding to the second line and the fifth line of the telephone cord respectively, so that the telephone cord has a digital network communication function.

5. The telephone cord having a digital transmission in accordance with claim 1, wherein all of the six metallic guide plates metallic guide plates are each inserted into the respective insertion slot corresponding to the six lines of the telephone cord respectively, so that the telephone cord has a telephone communication function and a digital network communication function.
